(19) United States
(12) Patent Application Publication
(10) Pub. No.: US 2014/0075822 A1
(43) Pub. Date: Mar. 20, 2014

(54) WILD FOWL DECOY SYSTEM

(71) Applicant: DDI, Inc., Dubuque, IA (US)

(72) Inventor: John Brian Priest, Dubuque, IA (US)

(21) Appl. No.: 14/032,003

(22) Filed: Sep. 19, 2013

Related U.S. Application Data
(60) Provisional application No. 61/703,078, filed on Sep. 19, 2012.

(51) Int. Cl. A01M 31/06

(52) U.S. Cl. CPC A01M 31/06
USPC 43/3; 43/2

(57) ABSTRACT

A wild fowl decoy apparatus comprises a monochromatic body having features generic to a plurality of wild fowl types. The body has a connection portion to releasably connect to a selected one of a plurality of different heads of the plurality of wild fowl types.

### CROSS-REFERENCE TO RELATED PATENT APPLICATIONS

The present application is a non-provisional application claiming priority under 35 USC 119(e) from U.S. Provisional Patent Application Ser. No. 61,703,078 filed on Sep. 19, 2012 by John Brian Priest and entitled WILD FOWL DECOY SYSTEM, the full disclosure of which is hereby incorporated by reference.

### BACKGROUND

Decoys are sometimes utilized to attract wild fowl for observation or hunting. Maintaining, storing and transporting a collection of different decoys for different wildfowl and four different seasons or conditions is expensive and imposes large storage and transportation demands.

### BRIEF DESCRIPTION OF THE DRAWINGS

FIG. 1 is a perspective view of an example wildfowl decoy kit.

FIG. 2 is a perspective view of another example wildfowl decoy kit.

### DETAILED DESCRIPTION OF THE EXAMPLES

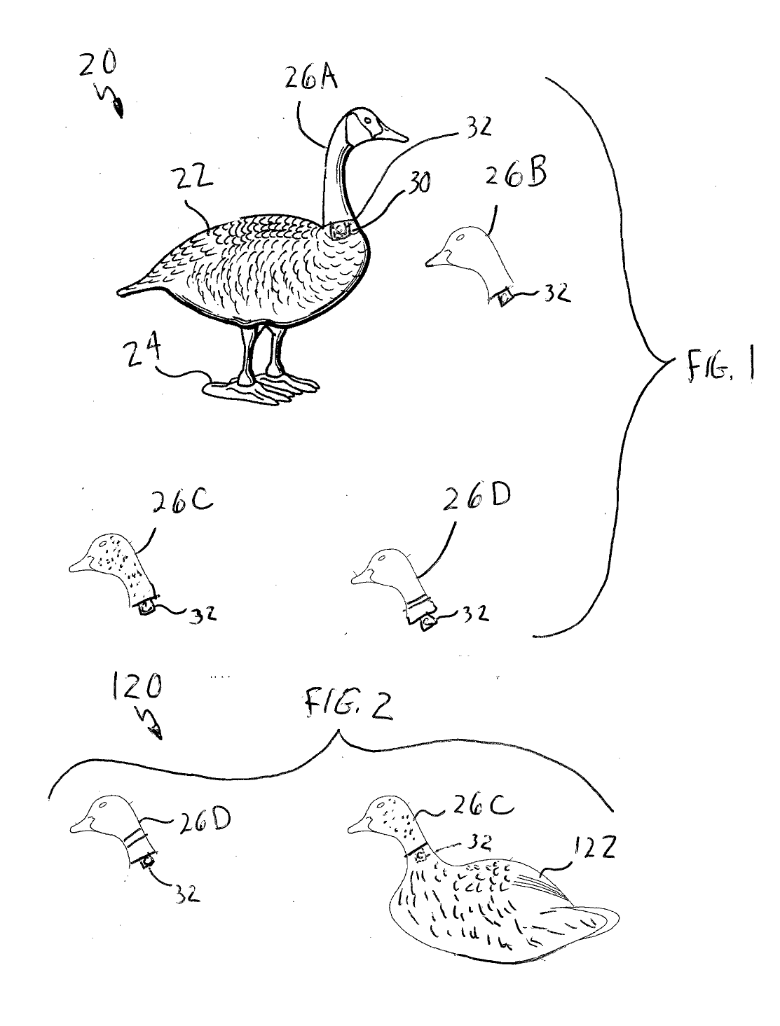

FIG. 1 illustrates an example wildfowl decoy kit 20. As will be described hereafter, wildfowl decoy kit 20 facilitates the use of a single wildfowl body in forming any one of a variety of different wildfowl decoys. Because kit 20 facilitates use a single body with any one of a variety of different wildfowl head, a hunter may adapt his or her decoys to particular hunting characteristics and hunting preferences more conveniently at a lower cost and with less storage/transportation demands.

Wildfowl decoy kit 20 comprises wild fowl body 22, stand 24 and interchangeable wild fowl heads 26A, 26B, 26C and 26D (collectively referred to as heads 26). Wildfowl body 22 comprises a carved, molded or otherwise fabricated three-dimensional dimensional body representing the body, breast and wings, of a wildfowl. Wildfowl body 22 has a connection portion 30 (schematically illustrated) to releasably connect body 22 to one of heads 26. In one example, the connection portion 30 may comprise a bore having internal threads for receiving an externally threaded post of a head 26. In other examples, the connection portion 30 may comprise a bore for receiving a posts extending from a heads 26 or may comprise a post for inserting into a bore of a head 26. In yet other implementations, connection portion 30 may comprise other fastening or interconnecting mechanisms. As a result, wildfowl body 22 may be interchangeably and repeatedly attached to any of heads 26.

Wildfowl body 22 omits body features, shapes, coloring or structures that are specific to a particular wildfowl type of heads 26. Said another way, wildfire body 22 consists of features that are generic to each of the plurality of wildfowls head 26. As a result, wildfowl body 22 may be employed with each of the heads 26 without creating visual discrepancies or inconsistencies between the particular one of heads 26 that is connected to body 22.

In the example illustrated, wild fowl body 22 is monochromatic, having an entire outer surface of one color. As a result, wildfire body 22 does not have a color or combination of colors that would otherwise create visual discrepancies or inconsistencies between the particular one head 26 that is connected to body 22. In one implementation, wildfowl body 22 is black. As a result, wildfowl body provides a highly visible dark silhouette of the wildfowl body from above (such as to wildfowl in flight). At the same time, the black color does not grade inconsistency with the particular head 26 attached to body 22. The monochromatic black color of body 22 further facilitates use of body 22 with each of the interchangeable heads 26 without creating inconsistencies that may detract from the effectiveness of the particular decoy formed by body 22 and the particular head 26.

In the example illustrated, body 22 is configured for use with one or more heads 26 of different wildfowl genus having substantially different sizes or size ranges. In such an implementation, body 22 is disproportionately sized with respect to each of the different wildfowl genus so as to have a selected size between the different sizes or size ranges of the different wildfowl genus. For example, in one implementation, one of heads 26 may comprise the head of a duck (a first genus) while the other of heads 26 may comprise the head of a goose (a second genus) because a much larger size. In such an implementation, body 22 has a size between that of a duct in a goose. For example, in one of limitation, body 22 has a size less than that of an average adult male goose and greater than that of an average adult male duck. As a result, body 22 may be utilized with different wild file genus having subject or different sizes, but as a compromise size making body 22 amenable for use in forming a decoy of either genus.

Stand 24 comprises a structure which elevates and supports body 22 above a support surface, such as the ground. In the example illustrated, stand 24 comprises feet and legs releasably or removably connected to a bottom of body 22. In one implementation, the legs and feet forming stand 24 are removably attached to body 22, enabling different legs and feet to be attached to body 22 to match the particular wildfowl type of head 26. In other implementations, the feet and legs forming stand 24 may be permanently or fixedly attached to body 22 are integrally formed as part of body 22. In such an implementation, feet and legs may be generic to each of the plurality of different wildfowl types provided by heads 26. In yet other embodiments, stand 24 may have other configurations, such as a tripod, circular disk-like stand, post or other supporting structure. In other implementations where the decoy formed by body 22 and one of heads 26 is a floating decoy, stand 24 may be omitted.

Wildfowl heads 26 comprise heads of different wildfowl types. Each of heads 26 has a connection portion 32 (schematically shown) for interacting with the connection portion 30 of body 22. As noted above, connection portion 32 may comprise a post, may comprise a post receiving bore, may comprise an internal or externally threaded member, may comprise a snap that fastener or may comprise other securement mechanisms for releasably attaching the particular head 26 to body 22.

Each of heads 26 (the term “head” also including and encompassing the associated neck) is configured to resemble a different wildfowl type. In the example illustrated, head 26A resembles a first wildfowl genus, a goose, while head 26B resembles a second different wildfowl genus, a duck. Heads 26A and 26B are interchangeably connectable to body 22 to form a decoy for use by a hunter when goose hunting or when duck hunting. Even though body 22 includes features generic to both geese and ducks, even though body 22 may be monochromatic or even black and even though body 22 may have a size or proportions that are not specific to geese or specific to ducks, heads 26A and 26B each have specific sizes, proportions, shapes, eye size, beak size, and coloring that are specific to the particular genus. Even though body 22 generic and presents a darkened or black silhouette from above to the wildfowl flying overhead, the particular head 26A or 26B provides visual distinctive coloring and characteristics for attracting the overhead flying wildfowl. As a result, a hunter need merely purchase, store and transport a single body 22 and each of heads 26A and 26B to selectively form a desired decoy depending upon whether the hunter is hunting geese or hunting ducks.

Head 26C comprises a head of the wildfowl type comprising a different species of duck as compared to the species of duck of head 26B. Head 26 may comprise different proportions, different eye characteristics, different beak characteristics, different colorings and the like as compared to head 26B. Head 26C enables a hunter to adapt, on-the-fly, to different hunting characteristics where different duck species may be present by simply interchanging heads 26B and 26C.

Head 26D comprises a head of the wildfowl type comprising a different sex or gender of duck as compared to the sex or gender of duck of head 26C. in one implementation, heads 26C and 26D may be of the same genus and the same species of duck, but may be for a female and male, respectively. For example, in one implementation, head 26C may be a head of a female or hen, while head 26D may be a head of a male or drake duck. Heads 26C and 26D and a really hundred to adapt, on-the-fly, two different hunting characteristics when a female or male wildfowl gender is desirable to attract wildfowl targets.

FIG. 2 illustrates another example wildfowl decoys system or kit 120. Kit 120 is similar to Kit 20 except that kit 120 comprises body 122 in place of body 22. As with kit 20, kit 120 comprises a plurality of heads 26 of different wild fowl types. In the example illustrated, kit 120 comprises heads 26C and 26D described above. In some implementations, kit 120 may additionally comprise other wildfowl heads 26 of different types, wherein the different types may comprise different wildfowl genus, different wildfowl species, different wildfowl genders and combinations thereof.

Wildfowl body 122 is similar to body 22 described above except that body 122 omits stand 24, wherein body 122 is configured to float, so as to form a floating decoy when combined with one of heads 26. Like body 22, body 122 includes features generic to each of the different wildfowl types for which interchangeable heads 26 may be attached to body 122. Like body 22, body 122 comprises a monochromatic body, nominally comprising an all-black body. Like body 22, body 122 may have a size between the average sizes of two wildfowl genus, wherein the size of body 122 is larger than 75% of one genus and smaller than 75% of another genus for which different genus heads are interchangeably mountable to body 122. As with kit 20, kit 120 facilitates use a single body with any one of a variety of different wildfowl head, enabling a hunter to adapt his or her decoys to particular hunting characteristics and hunting preferences more conveniently at a lower cost and with less storage/transportation demands.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

1. A wild fowl decoy apparatus comprising:
a monochromatic body having features generic to a plurality of wild fowl types, the body having a connection portion to releasably connect to a selected one of a plurality of different heads of the plurality of wild fowl types.

2. The apparatus of claim 1 further comprising:
a first wild fowl head of a first species; and
a second wild fowl head of a second species, wherein the first wild fowl head and the second wild fowl head are interchangeably connectable to the monochromatic body.

3. The apparatus of claim 1, wherein the monochromatic body has features generic to an adult male goose and an adult male duck, wherein the body has a size less than an average adult male goose and greater than an average adult male duck.

4. The apparatus of claim 1, further comprising:
a first wild fowl head of a male of a first species; and
a second wild fowl head of a female of the first species.

5. The apparatus of claim 1, wherein the monochromatic body is black visually providing a silhouette of a wildfowl body.

6. The apparatus of claim 1 further comprising a stand connected to the monochromatic body to support the monochromatic body.

7. The apparatus of claim 6, wherein the stand comprises legs and feet of a wildfowl.

8. The apparatus of claim 1, wherein the monochromatic body lacks legs and is configured to float.

9. A wildfowl decoy system kit comprising:
a monochromatic body having features generic to a plurality of wild fowl types, the body having a connection portion to releasably connect to a selected one of a plurality of different heads of the plurality of wild fowl types;
a first wild fowl head of a first type; and
a second wild fowl head of a second type, wherein the first wild fowl head and the second wild fowl head are interchangeably connectable to the monochromatic body.

10. The wildfowl decoy system kit of claim 9, wherein the first type comprises a first wild fowl genus and wherein the second type comprises a second wildfowl genus.

11. The wildfowl decoy system kit of claim 10, wherein the first wildfowl genus comprises a duck and wherein the second wildfowl genus comprises a goose.

12. The wildfowl decoy system kit of claim 9, wherein the first type comprises a first species and wherein the second type comprises a second species.

13. The wildfowl decoy system kit of claim 9, wherein the first type comprises a male of a first species and wherein the second type comprise a female of the first species.

14. The wildfowl decoy system kit of claim 9, wherein the monochromatic body is black, visually providing a silhouette of a wildfowl body.

15. The wildfowl decoy system kit of claim 9 further comprising a stand connected to the monochromatic body to support the monochromatic body.

16. The wildfowl decoy system kit of claim 15, wherein the stand comprises legs and feet of a wildfowl.

17. The wildfowl decoy system kit of claim 9, wherein the monochromatic body lacks legs and is configured to float.

18. A method comprising:
providing a monochromatic body having features generic to a plurality of wild fowl types, the body having a connection portion to releasably connect to a selected one of a plurality of different heads of the plurality of wild fowl types;
connecting a first wild fowl head of a first type to the monochromatic body;
disconnecting the first while head from the monochromatic body; and
connecting a second wild fowl head of a second type.

19. A wildfowl decoy apparatus comprising:
a wild fowl body generic to a plurality of wild fowl types, the body having a connection portion to releasably connect to a selected one of a plurality of different heads of the plurality of wild fowl types.

20. The apparatus of claim 19 further comprising:
a first wild fowl head of a first type; and
a second wild fowl head of a second type, wherein the first wild fowl head and the second wild fowl head are interchangeably connectable to the body.

21. A wildfowl decoy kit comprising:
a first wild fowl head of a first type; and
a second wild fowl head of a second type, wherein the first wild fowl head and the second wild fowl head are interchangeably connectable to a wildfowl body generic to the first type and the second type.
